(19) United States
(12) Patent Application Publication
(10) Pub. No.: US 2003/0089192 A1
(43) Pub. Date: May 15, 2003

(54) Steering wheel and manufacturing method therefor

(76) Inventors: Yasumasa Shimizu, Hamamatsu-shi (JP); Toshiharu Fukushima, Hamamatsu-shi (JP); Toru Makino, Inasa-gun (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/277,041

(22) Filed: Oct. 22, 2002

(30) Foreign Application Priority Data
Oct. 23, 2001 (JP) 2001-325423
Oct. 18, 2002 (JP) 2002-304159

(51) Int. Cl. B62D 1/04

(52) U.S. Cl. 74/552

(57) ABSTRACT

A steering wheel for an automobile is provided. The steering wheel comprises: a surface element formed by stacking a decorative layer and a reinforce layer; a core material layer disposed to the inside of the surface elements; and a metal core disposed to the inside of the core material layer, the surface elements, the core material layer, and the metal core being integrated to form the steering wheel, wherein the reinforce layer is made of a sheet molding compound or a bulk molding compound. A manufacturing method for a steering wheel is also provided. The manufacturing method comprises the steps of: forming a metal core; forming a surface element including a decorative layer and a reinforce layer which are stacked together; and forming a core material layer between the metal core and the surface element so that the core metal, the core material layer, and the surface element are integrated, wherein the reinforce layer is formed by heating and pressing a sheet molding compound or a bulk molding compound. Accordingly, steering wheel has high mechanical strength, and is easy to be manufactured.

### BACKGROUND OF THE INVENTION

1. Field of the Invention

This invention relates to a steering wheel for an automobile, and relates to a manufacturing method therefor, more specifically, this invention relates to a steering wheel comprising a surface layer made of a woody material, and a core element made of resin and disposed to the inside of the surface layer, and relates to a manufacturing method for such a steering wheel.

2. Background Art

In general, a steering wheel for an automobile comprises a metal core, a core element wrapping around the metal core, and a surface element, and these three elements are integrated together.

FIG. 4 is a cross-sectional view showing a conventional steering wheel.

In general, a steering wheel 1 comprises a metal core 2 consisting of a solid or tubular metal element, a core material layer 3 made of resin and wrapping around the metal core 2 and a decorative layer 4. Furthermore, in the steering wheel 1, the decorative layers 4 and 4 which were independently molded are joined together, and the seams 5 and 5 formed therebetween are located in a plane crossing the metal core 2.

The manufacturing method for such a steering wheel is outlined below with reference to FIGS. 5 and 6.

As a first step, the decorative layer 4 is preliminarily shaped by a curved-surface shaping process. Next, a set of forming molds 7, i.e., an upper mold 7a and a lower mold 7b, is provided. The lower mold 7b has a cavity 8 formed therein, and the inner surface of the cavity 8 has the same shape as the outer surface of either the front side or the back side of steering wheel 10. The upper mold 7a has a projected portion 9 on its abutting surface to abut the lower mold 7b. The projected portion 9 has a semicircular cross section equivalent to half of the metal core 2, and is formed so as to be disposed along the circular center line of the open end of the cavity 8 when the upper mold 7a and the lower mold 7b abut each other.

Next, the preliminarily shaped decorative layer 4 is put in the cavity 8 of a set of the molds 7 to form the front side of the steering wheel 1, the upper mold 7a is moved to close the cavity 8, and a foamable resin is injected into the set of molds 7. Then, the foamable resin is foamed and hardened to form the core element 3 so that the core element 3 is integrated with the decorative layer 4; thus, a formed body for the front side of the steering wheel 1 is obtained (see, for example, Japanese Unexamined Patent Application, First Publication No. Hei 08-310407).

In a next step, the metal core 2 is put in a groove 3a formed by the projected portion 9 of the upper mold 7a, then the integrated steering wheel 1 is formed by adhering the metal core 2 to formed bodies for the front and back sides of the steering wheel 1 with adhesive or the like. After surface-finishing the seams between the formed bodies with sandpaper or the like, if necessary, a coloring process, a painting process, a grinding process, or the like is applied to obtain the steering wheel 1.

In such a method as described above, a problem is experienced in that formability of the elements is unacceptable when the metal core 2, core material layer 3, and the decorative layers 4 and 4 are integrated because the pre-formed decorative layers 4 and 4 have low accuracy and low mechanical strength. In addition, another problem is experienced that the finished shape of the steering wheel 1 is unacceptable because the accuracy in shape at the seams between the decorative layer 4 for the front side of the steering wheel 1 and the decorative layer 4 for the back side thereof is insufficient. In addition, a further problem is experienced in that because adhesive is used to adhere the metal core 2 to the formed bodies for the front and back sides of the steering wheel 1, the adhesive leaks through the seams between the decorative layer 4 for the front side of the steering wheel 1 and the decorative layer 4 for the back side thereof, and the leaked adhesive degrades the appearance of the decorative layer 4. Furthermore, another problem is experienced in that because forming the core element 3 requires a relatively long time, e.g., 20 to 30 minutes, a large number of molds are required for mass-production of the steering wheel 1 using this method.

### SUMMARY OF THE INVENTION

In view of the above circumstances, an object of the present invention is to provide a steering wheel which consists of elements that have high mechanical strength and sufficient formability, and which can be efficiently produced.

Another object of the present invention is to provide a manufacturing method for such a steering wheel.

The above object is achieved by providing a steering wheel, comprising: a surface element including a decorative layer and a reinforce layer stacked inside of the decorative layer; a core material layer disposed to the inside of the surface elements; and a metal core disposed to the inside of the core material layer, the surface elements, the core material layer, and the metal core being integrated to form the steering wheel, wherein the reinforce layer is made of a sheet molding compound or a bulk molding compound.

The above object is achieved by providing a manufacturing method for a steering wheel, comprising the steps of: forming a metal core; forming a surface element including a decorative layer and a reinforce layer which are stacked together; and forming a core material layer between the metal core and the surface element so that the core metal, the core material layer, and the surface element are integrated, wherein the reinforce layer is formed by heating and pressing a sheet molding compound or a bulk molding compound.

The above object is also achieved by providing a manufacturing method for a steering wheel, comprising the steps of: providing a metal core; preliminarily shaping a decorative layer to a predetermined shape; disposing the decorative layer in a mold; disposing a sheet molding compound or a bulk molding compound to the inside of the decorative layer; forming a reinforce layer by heating and pressing the sheet molding compound or the bulk molding compound so as to be integrated with the decorative layer so as to form a surface element; and forming a core material layer between the metal core and the surface element so that the core metal, the core material layer, and the surface element are integrated.

In the above manufacturing method for a steering wheel, the step of forming a core material layer may comprise injecting resin between the metal core and the surface element.

### BRIEF DESCRIPTION OF THE DRAWINGS

FIG. 1 is a cross-sectional view showing an example of the steering wheel according to the present invention.

FIG. 2 is a schematic cross-sectional view showing a manufacturing method for the steering wheel according to the present invention.

FIG. 3 is a schematic cross-sectional view showing a manufacturing method for the steering wheel according to the present invention.

FIG. 4 is a cross-sectional view showing a conventional manufacturing method for a conventional steering wheel.

FIG. 5 is a cross-sectional view showing a conventional manufacturing method for a conventional steering wheel.

FIG. 6 is also a cross-sectional view showing a conventional manufacturing method for a conventional steering wheel.

### DETAILED DESCRIPTION OF THE PREFERRED EMBODIMENTS

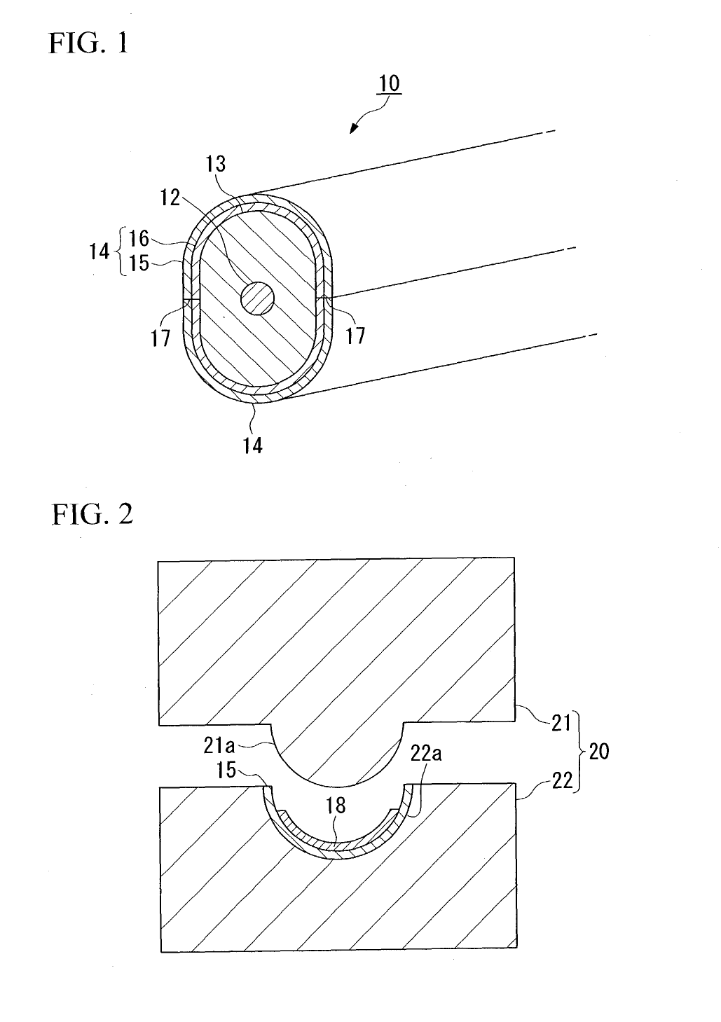

A preferred embodiment of the steering wheel according to the present invention will be explained with reference to FIGS. 1 and 2.

FIG. 1 is a cross-sectional view showing an example of the steering wheel according to the present invention.

The steering wheel 10 primarily comprises a metal core 12, a core material layer 13 wrapping around the metal core 12, and surface elements 14. Each of the surface elements 14 is formed by stacking a decorative layer 15 as a surface layer and a reinforce layer 16 disposed to the inside of the decorative layer 15.

In the steering wheel 10, the surface elements 14 and 14 which were independently molded are joined together at seams 17 and 17. The seams 17 and 17 are located in a plane crossing the metal core 12.

A coloring process, a painting process, a grinding process, or the like may be applied to the surface of the steering wheel 10, if necessary.

The metal core 12 consists of a solid or tubular metal element made of, for example, iron or the like. The shape of the cross section of the metal core 12 is not limited to a circular shape, but may be, for example, a V-shape, a U-shape, or the like. The metal core 12 may be formed by die-casting a light metal such as aluminum or magnesium.

The core material layer 13 is made of synthetic resin. Examples of synthetic resin to form the core material layer 13 are as follows: foamed resin such as urethane foam, or epoxy foam; thermosetting resin such as urethane resin, phenol resin, or thermosetting polyester; and thermoplastic resin such as polyphenylene sulfide, polycarbonate, acrylonitrile-butadiene-styrene copolymer resin (hereinafter abbreviated as “ABS resin”), polyether imide, polypropylene, polyethylene, acrylic resin, Poly(ether-ether-ketone), polyvinyl chloride, or nylon. Among these materials, foamable resin such as foamable urethane resin, or foamable epoxy resin is preferably used.

The density of the core material layer 13 is preferably from 0.1 to 0.5 g/cm³, and more preferably from 0.1 to 0.3 g/cm³. If the density of the core material layer 13 is less than 0.1 g/cm³, the strength of the core material layer 13 is insufficient. On the other hand, if the density of the core material layer 13 is greater than 0.5 g/cm³, the formability of the core material layer 13 is degraded.

The bending strength of the core material layer 13 is preferably from 0.5 to 1.5 MPa, and more preferably from 0.7 to 1.2 MPa. If the bending strength of the core material layer 13 is less than 0.5 MPa, the core material layer 13 cannot hold the metal core 12. If the bending strength of the core material layer 13 is greater than 1.5 MPa, stress caused by the thermal expansion of the core material layer 13 is increased; consequently, the coating film on the decorative layer 15 may have cracking along the seams 17 and 17.

The coefficient of linear expansion of the core material layer 13 is preferably from 0 to 6×10⁻⁵/° C., and more preferably from 0 to 4×10⁻⁵/° C. If the coefficient of linear expansion of the core material layer 13 is greater than 6×10⁻⁵/° C., the reinforce layer 16 wrapping around the core material layer 13 may be deformed, and the coating film formed on the outer surface of the reinforce layer 16 may have cracking, due to the thermal expansion of the core material layer 13.

The surface element 14 is formed by stacking the decorative layer 15 and the reinforce layer 16 so as to be integrated together, and by processing to be curved-surface. The thickness of the surface element 14 is preferably from 0.5 to 3.0 mm, and more preferably from 0.5 to 1.0 mm near the seam 17, and is preferably from 0.5 to 7.0 mm, and more preferably from 0.5 to 3.0 mm at the top thereof.

The material to form the decorative layer 15 may be selected from: (1) a 3-ply decorative sheet in which woody plies are stacked on both surfaces of a thin metal plate; (2) a backed decorative sheet in which a backing material is applied onto a woody ply; (3) a plywood in which a woody ply is stacked, or woody plies are stacked onto the back surface of a woody ply; (4) a ply and resin composite material in which a woody ply and a thin resin plate are stacked; or (5) a film material in which a pattern such as a wood grain pattern is printed on a non-woody material.

The above materials (1) to (5) will be more specifically explained below.

(1) 3-Ply Decorative Sheet

A 3-ply decorative sheet to be used is formed by stacking woody plies as surface layers on both surfaces of a thin metal plate using adhesive or the like so as to be integrated together. The adhesive used to adhere the thin metal plate and the woody plies is not specifically limited, but thermosetting adhesive having heat resistance is preferred.

As the thin metal plate, a metal plate which has flexibility and which has a sufficient strength to reinforce the woody plies stacked on both surfaces thereof. Although the thickness of the thin metal plate should be selected depending on the metal material used, thickness from 0.01 to 0.50 mm is generally preferred. The material for the thin metal plate may be selected from aluminum, aluminum alloy, magnesium, magnesium alloy, titanium, titanium alloy, copper, copper alloy, iron, iron alloy, brass, or stainless steel, etc.

One woody ply to be a surface layer and the other woody ply to be an inner layer may be the same each other; however, specifically, one woody ply to be a surface layer preferably has a beautiful wood grain pattern. The thickness of the woody ply forming the surface layer or inner layer is preferably from 0.15 to 1.00 mm.

(2) Backed Decorative Sheet

A preferable backed decorative sheet to be used is formed by applying a backing material such as non-woven fabric made of, for example, Japanese paper having an area density of approximately 25 to 100 g/m², chemical fibers, or the like as a backing onto a woody ply whose thickness is from 0.15 to 1.00 mm. When such a backed decorative material is used, primer is preferably applied to the back surface thereof so as to increase the adhesion between the decorative layer 15 and the reinforce layer 16 attached to the back surface of the decorative layer 15. As the primer, acrylic resin, epoxy resin, urethane resin, or the like may be used. The thickness of the primer is preferably from 20 to 100 μm.

(3) Plywood

A plywood to be preferably used is formed by stacking a woody ply or woody plies onto the back surface of a woody ply, more preferably, a plywood in which one to seven woody plies are stacked onto the back surface of a woody ply is used. The thickness of the woody ply forming the surface layer of the plywood is preferably from 0.15 to 3.00 mm. The thickness of the plywood is preferably from 0.15 to 3.00 mm. If the thickness of the plywood is less than 0.15 mm, the shape retentivity of the plywood is degraded. On the other hand, if the thickness of the plywood is greater than 3.0 mm, the formability of the plywood is degraded.

(4) Ply and Resin Composite Material

A ply and resin composite material to be preferably used is formed by adhering, using such as a thermosetting adhesive having thermal resistance, a thin resin plate whose thickness is from 0.10 to 3.00 mm onto the back surface of a woody ply whose thickness is from 0.15 to 1.00 mm. The thin resin plate is preferably made of polyphenylene sulfide, polycarbonate, ABS resin, or the like.

(5) Film Material

A film material to be preferably used is a film having a designed pattern such as a plastic film printed a pattern thereon, or a film of a woven carbon fiber. The thickness of the reinforce layer 16 is preferably from 0.5 to 7 mm, and more preferably from 0.5 to 3 mm.

As the material to form the reinforce layer 16, a sheet molding compound or a bulk molding compound is used.

A sheet molding compound (hereinafter abbreviated as SMC) is prepared by impregnating a mixture containing an unsaturated polyester resin or a vinyl ester resin into glass fiber chopped strands (i.e., fiber strands cut in appropriate lengths), a glass fiber mat, a glass fiber roving cloth, or a non-woven fabric of organic fibers such as polyester, and by gelling the mixture. If necessary, the SMC may further contain a low shrinkage agent, a filling agent, a thickening agent, a mold release agent, or a coloring agent.

A bulk molding compound (hereinafter abbreviated as BMC) is a forming material which is formed by mixing or impregnating an unsaturated polyester resin or a vinyl ester resin containing a curing agent and a condensating agent into chopped strands of glass fibers, organic fibers such as polyester fibers, or the like, and by gelling the mixture. If necessary, the BMC may further contain a filling agent, a thickening agent, a mold release agent, or a coloring agent.

The mechanical strength, the elastic modulus, or the like of the above-mentioned SMC or BMC can be controlled by selecting or adjusting the amount, the lengths, or the like of the contained fibers.

Because the coefficients of linear expansion and the anisotropies of the above-mentioned SMC or BMC are relatively low, if the reinforce layer 16 is made of SMC or BMC, the elastic modulus, the mechanical strength, the thermally deformable temperature, or the like of the reinforce layer 16 may be increased. Therefore, the reinforce layer 16 has a high accuracy in shape, and the thermal expansion thereof at a high temperature can be restrained. Accordingly, the surface element 14,which is formed by stacking and integrating the decorative layer 15 and the reinforce layer 16, has high accuracy in shape, high mechanical strength, and exhibits excellent formability. The steering wheel 10 formed using the above-mentioned surface element 14 will exhibit improved torsional strength, impact strength, bending strength, or the like. Moreover, because the reinforce layer 16 has a high thermal resistance, cracking, along the seams 17 and 17, in the coating film formed on the surface of the decorative layers 15, can be prevented.

Specifically, the SMC has a high glass transition point (approximately 150° C.) and a high thermal resistance. Furthermore, because the SMC has a low coefficient of thermal shrinkage (some of the SMC exhibit no thermal shrinkage), when the BMC is used, defects in products such as shrinkage, cambering, or cracking will rarely occur, and an excellent stability in dimensions is obtained.

Because each of the glass fibers forming the BMC is relatively short, the glass fibers are uniformly scattered in the resin forming the BMC, and inner pressure during a shaping process is uniformly distributed; therefore, an excellent smoothness of the products can be obtained. In addition, despite of a low manufacturing cost of the BMC, the reinforce layer 16 having a high strength and high elastic modulus can be formed by using the BMC.

The bending strength of the reinforce layer 16 is preferably from 100 to 300 MPa, and more preferably from 150 to 250 MPa. If the bending strength of the reinforce layer 16 is less than 100 MPa, the rigidity of the entire steering wheel 10 is insufficient. If the bending strength of the reinforce layer 16 is greater than 300 MPa, the formability of the surface element 14 formed by stacking the decorative layer 15 and the reinforce layer 16 is degraded.

The Young's modulus of the reinforce layer 16 is preferably from 10 to 25 GPa, and more preferably from 15 to 20 GPa. If the Young's modulus of the reinforce layer 16 is less than 10 GPa, the rigidity of the entire steering wheel 10 is insufficient. If the Young's modulus of the reinforce layer 16 is greater than 25 GPa, the formability of the surface element 14 is degraded.

The coefficient of linear expansion of the reinforce layer 16 is preferably from 0 to 8×10⁻⁵/° C., and more preferably from 0 to 5×10⁻⁵/° C. If the coefficient of linear expansion of the reinforce layer 16 is greater-than 8×10⁻⁵/° C., the reinforce layer 16 may be deformed, and the coating film formed on the outer surface of the reinforce layer 16 may have cracking, due to thermal expansion at a high temperature.

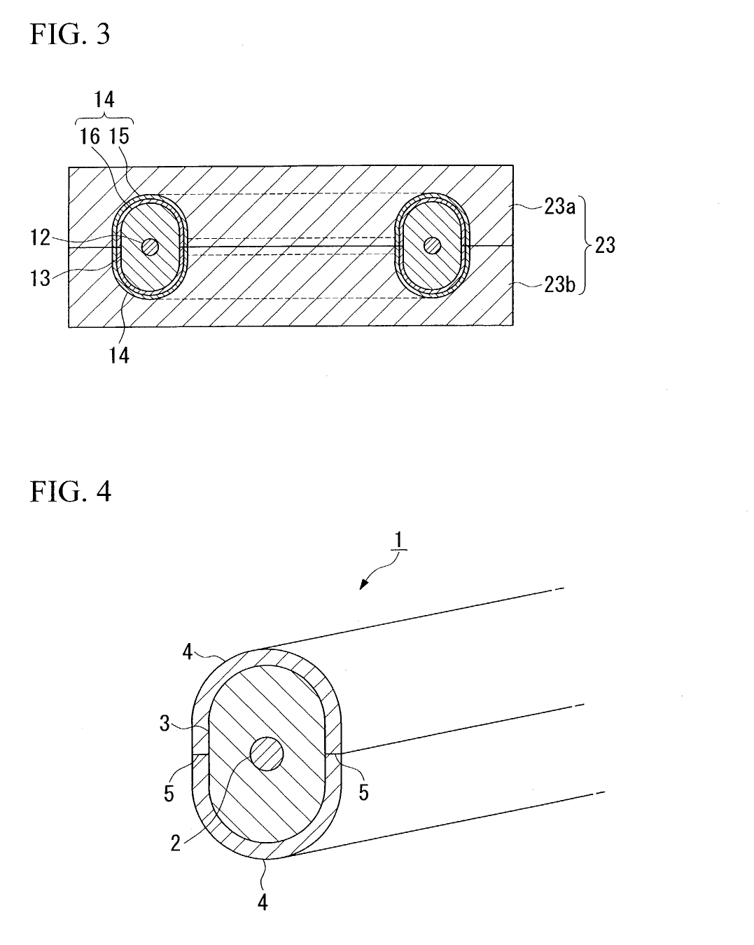

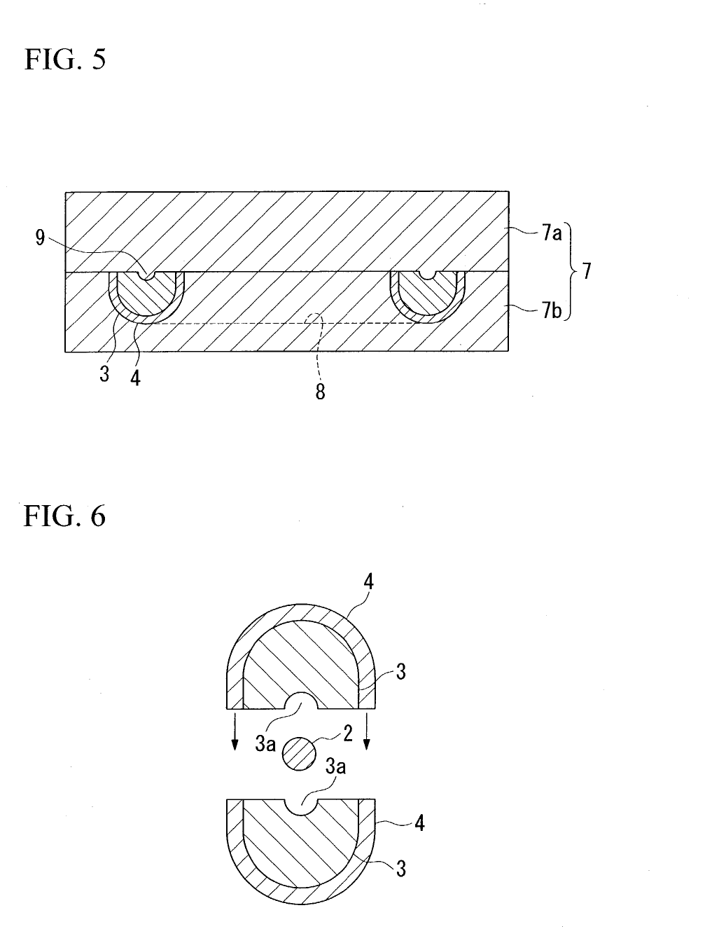

A manufacturing method for the steering wheel according to the present invention will be explained below with reference to FIGS. 2 and 3.

As a first step, one decorative layer 15 to form the front side of the steering wheel 10 and the other decorative layer 15 to form the back side of the steering wheel 10 are preliminarily shaped by a curved-surface shaping process, respectively. By these preliminary shaping processes, each of the decorative layers 15 are shaped in substantially the final surface shape of the steering wheel 10; however, it is not necessary to make each of the decorative layers 15 to be the final shape at this stage. Only one mold may be used for forming both of the front side and the back side decorative layers 15; alternatively, the preliminary shaping process for the back side decorative layer 15 may be performed using a mold having irregularity for gripping during use.

The preliminarily shaping process for the decorative layer 15 may be performed using a hot press process, a vacuum press process, a vacuum forming, a pressurized air forming, or the like, among which a hot press process and a vacuum press process are preferably used. The operating conditions for the hot press process are preferably set to 1 to 5 minutes at 100 to 150° C., and the operating conditions for vacuum press process are preferably set to 1 to 5 minutes at 100 to 150° C. The decorative layer 15 may be subjected to a known moistening process or a known alkaline treatment using ammonia so as to be softened. By applying such a pretreatment, to the decorative layer 15, cracking in the decorative layer 15 during the curved-surface shaping process can be prevented; thus, the formability thereof is improved.

Next, the reinforce layer 16 is formed, and the reinforce layer 16 is stacked onto the decorative layer 15 so as to obtain the integrated surface element 14.

In order to layer and integrate a forming material such as SMC or BMC with the decorative layer 15, first, a set of surface element forming molds 20 is provided. The set of surface element forming molds 20 consists of an upper mold 21 and a lower mold 22 which are movable with respect to each other to open or close the space therebetween. The lower mold 22 has a cavity 22a formed therein, and the inner surface of the cavity 22a has substantially the same shape as the outer surface of either the front side or the back side of steering wheel 10. The upper mold 21 has a projected portion 21a on its abutting surface to abut the lower mold 22. The projected portion 21 a has a semicircular cross section which is slightly smaller than the cross section of the cavity 22a, and is formed so as to be disposed along the circular center line of the open end of the cavity 22a when the upper mold 21 and the lower mold 22 abut each other. Next, the lower mold 22 is heated to 100 to 150° C., the preliminarily shaped decorative layer 15 is put in the cavity 22a of the lower mold 22, and the forming material 18 such as SMC or BMC having been cut into strips is applied to the decorative layer 15. Next, the upper mold 21 is moved to close the cavity 22a and then a heating and pressurizing forming step is performed, wherein the preferred conditions are as follows: the temperature of the molds is 100 to 150° C.; the mold retaining pressure is 2 to 8 MPa; and the holding period in the mold is 3 to 5 minutes. After maintaining these conditions for a predetermined period, the integrated surface element 14, consisting of the decorative layer 15 and the reinforce layer 16, is removed from the molds.

After forming the surface element 14, undesirable portions such as flashes produced during the shaping process are removed from the surface element 14.

Next, a set of molds 23 for forming a formed body for the steering wheel is provided. A set of molds 23 consists of an upper mold 23a and a lower mold 23b which are movable with respect to each other to open or close the space therebetween. Then, the surface element 14 to form the front side of the steering wheel 10 and the surface element 14 to form the back side of the steering wheel 10 are disposed in the cavity 24 of a set of forming molds 23 so as to abut each other, while the metal core 12 is disposed at the center thereof.

Next, the upper mold 23a is moved to close the cavity 24, and then a foamable resin such as a foamable urethane resin, a foamable epoxy resin, or the like is supplied into the space between the surface elements 14 and 14 and the metal core 12 so as to form the core material layer 13, and so as to integrate the surface elements 14 and 14, the metal core 12, and thus the formed body for the steering wheel is obtained. In the forming step for the core material layer 13, the preferred temperature is 20 to 50° C., and the preferred duration is approximately 3 to 15 minutes.

Then, the formed body for the steering wheel is removed from a set of molds 23, the seams 17 and 17 between the surface elements 14 and 14 are surface-finished using sandpaper or the like, and if necessary, a coloring process, a painting process, a grinding process, or the like is applied to obtain the steering wheel 10.

As explained above, in the manufacturing method for a steering wheel according to the present invention, because the reinforce layer is made of SMC or BMC using a heating and pressurizing shaping process, the accuracy in shape and the mechanical strength of the surface element, which is formed by stacking and integrating the decorative layer and the reinforce layer, are increased; therefore, the steering wheel can be easily formed by integration.

In addition, because the reinforce layer is made of SMC or BMC using a heating and pressurizing shaping process, the forming time for the reinforce layer is shortened; therefore, the manufacturing efficiency is improved.

Furthermore, because the surface element, the core material layer, and the metal core are integrated when the core material layer is formed, an adhesive is not required; therefore, degradation of the appearance of the decorative layer due to a leaked or flashed adhesive can be prevented. In addition, the number of the manufacturing steps are reduced, and the manufacturing efficiency is improved.

In order to clarify the advantageous effects of the present invention, a more specific example of the steering wheel according to the present invention will be explained below with reference to FIGS. 1 to 3.

### EXAMPLE 1

A backed decorative layer, in which a non-woven polyester fabric is applied at an area density of 50 g/m² onto a woody ply having a thickness of 0.2 mm, was provided as the decorative layer 15. Then, the backed decorative layer was preliminarily shaped using a curved-surface shaping process including a hot press step. The operating conditions for the hot press step were set to 120° C. for 2 minutes.

Next, material, in which an unsaturated polyester resin was impregnated into glass fiber chopped strands so that 30 wt. % of glass fiber chopped strands were contained, was provided as an SMC material.

Next, the lower mold 22 of a set forming molds 20 was heated to 140° C., the preliminarily shaped decorative layer 15 was put in the cavity 22a of the lower mold 22, and the SMC material 18 having been cut into strips was applied to the decorative layer 15.

Next, the upper mold 21 was moved to close the cavity and then a heating and pressurizing forming step was performed, where the operating conditions were set as follows: the temperature of the molds was 140° C.; the mold retaining pressure was 3 MPa; and the holding period in the mold was approximately 3 minutes. After maintaining these conditions for a predetermined period, the integrated surface element 14 consisting of the decorative layer 15 and the reinforce layer 16 was removed from the molds. The thickness of the formed surface element 14 was approximately 1.5 mm.

Then, undesirable portions such as flashes produced during the shaping process were removed from the surface element 14.

Next, the surface element 14 for the front side of the steering wheel 10 and the surface element 14 for the back side of the steering wheel 10 were disposed in the cavity 24 of a set of forming molds 23 so as to abut each other, while the metal core 12 was disposed at the center thereof.

Next, the upper mold 23a was moved to close the cavity, and then a foamable urethane resin was supplied into the space between the surface elements 14 and 14 and the metal core 12 so as to form the core material layer 13, and so as to integrate the surface elements 14 and 14 and the metal core 12, and thus a formed body for the steering wheel was obtained. In the forming step for the core material layer 13, the temperature was set to 50° C., and the duration was set to approximately 10 minutes.

Then, the formed body for the steering wheel was removed from the molds 23, the seams 17 and 17 between the surface elements 14 and 14 were surface-finished using sandpaper or the like, and as required, a coloring process, a painting process, a grinding process, or the like was applied to obtain the steering wheel 10.

### EXAMPLE 2

A backed decorative layer in which a non-woven polyester fabric is applied at an area density of 50 g/m² onto a woody ply having a thickness of 0.2 mm was provided as the decorative layer 15. Then, the backed decorative layer was preliminarily shaped using a curved-surface shaping process including a hot press step. The operating conditions for the hot press step were set to 120° C. for 2 minutes.

Next, material, in which an unsaturated polyester resin was impregnated into glass fiber needles so that 30 wt. % of glass fiber needles were contained, was provided as an SMC material.

Next, the lower mold 22 of a set forming molds 20 was heated to 140° C., the preliminarily shaped decorative layer 15 was put in the cavity 22a of the lower mold 22, and the SMC material 18 having been cut into strips was applied to the decorative layer 15.

Next, the upper mold 21 was moved to close the cavity and then a heating and pressurizing forming step was performed, where the operating conditions were set as follows: the temperature of the molds was 140° C.; the mold retaining pressure was 3 MPa; and the holding period in the mold was approximately 3 minutes. After maintaining these conditions for a predetermined period, the integrated surface element 14 consisting of the decorative layer 15 and the reinforce layer 16 was removed from the molds. The thickness of the formed surface element 14 was approximately 1.5 mm.

Then, undesirable portions such as flashes produced during the shaping process were removed from the surface element 14.

Next, the surface element 14 for the front side of the steering wheel 10 and the surface element 14 for the back side of the steering wheel 10 were disposed in the cavity 24 of a set of forming molds 23 so as to abut each other, while the metal core 12 was disposed at the center thereof.

Next, the upper mold 23a was moved to close the cavity, and then a foamable urethane resin was supplied into the space between the surface elements 14 and 14 and the metal core 12 so as to form the core material layer 13, and so as to integrate the surface elements 14 and 14 and the metal core 12, and thus a formed body for the steering wheel was obtained. In the forming step for the core material layer 13, the temperature was set to 50° C., and the duration was set to approximately 10 minutes.

Then, the formed body for the steering wheel was removed from the molds 23, the seams 17 and 17 between the surface elements 14 and 14 were surface-finished using sandpaper or the like, and as required, a coloring process, a painting process, a grinding process, or the like was applied to obtain the steering wheel 10.

Industrial Applicability

As explained above, the steering wheel according to the present invention comprises: a surface element formed by stacking a decorative layer and a reinforce layer; a core material layer disposed to the inside of the surface elements; and a metal core disposed to the inside of the core material layer, the surface elements, the core material layer, and the metal core being integrated to form the steering wheel, wherein the reinforce layer is made of a sheet molding compound or a bulk molding compound. Accordingly, the steering wheel has high mechanical strength such as torsional strength, impact strength, bending strength, and the like.

The manufacturing method for a steering wheel according to the present invention comprises the steps of: forming a metal core; forming a surface element including a decorative layer and a reinforce layer which are stacked together; and forming a core material layer between the metal core and the surface element so that the core metal, the core material layer, and the surface element are integrated, wherein the reinforce layer is formed by heating and pressing a sheet molding compound or a bulk molding compound. Accordingly, the accuracy in shape and the mechanical strength of the surface element, which is formed by stacking and integrating the decorative layer and the reinforce layer, are increased; therefore, the steering wheel can be easily formed by integration. In addition, the forming time for the reinforce layer is shortened; therefore, the manufacturing efficiency is improved. Furthermore, because an adhesive is not required, degradation of the appearance of the decorative layer due to a leaked or flashed adhesive can be prevented.

The manufacturing method for a steering wheel according to the present invention may comprise the steps of: forming a metal core; preliminarily shaping a decorative layer to a predetermined shape; disposing the decorative layer in a mold; disposing a sheet molding compound or a bulk molding compound to the inside of the decorative layer; forming a reinforce layer by heating and pressing the sheet molding compound or the bulk molding compound so as to be integrated with the decorative layer so as to form a surface element; and forming a core material layer between the metal core and the surface element so that the core metal, the core material layer, and the surface element are integrated. Accordingly, the number of the manufacturing steps are reduced, and the manufacturing efficiency is improved.

Although the invention has been described in detail herein with reference to its preferred embodiments and certain described alternatives, it is to be understood that this description is by way of example only, and it is not to be construed in a limiting sense. It is further understood that numerous changes in the details of the embodiments of the invention, and additional embodiments of the invention, will be apparent to, and may be made by, persons of ordinary skill in the art having reference to this description. It is contemplated that all such changes and additional embodiments are within the spirit and true scope of the invention as claimed.

What is claimed is:

1. A steering wheel, comprising:
a surface element including a decorative layer and a reinforce layer stacked inside of said decorative layer;
a core material layer disposed to the inside of said surface elements; and
a metal core disposed to the inside of said core material layer, said surface elements, said core material layer, and said metal core being integrated to form said steering wheel,
wherein said reinforce layer is made of a sheet molding compound or a bulk molding compound.

2. A manufacturing method for a steering wheel, comprising the steps of:
providing a metal core;
forming a surface element including a decorative layer and a reinforce layer which are stacked together; and
forming a core material layer between said metal core and said surface element so that said core metal, said core material layer, and said surface element are integrated,
wherein said reinforce layer is formed by heating and pressing a sheet molding compound or a bulk molding compound.

3. A manufacturing method for a steering wheel, comprising the steps of:
providing a metal core;
preliminarily shaping a decorative sheet to a predetermined shape;
disposing said decorative sheet in a mold;
disposing a sheet molding compound or a bulk molding compound to the inside of said decorative sheet;
forming a reinforce layer by heating and pressing said sheet molding compound or said bulk molding compound so as to be integrated with said decorative sheet so as to form a surface element; and
forming a core material layer between said metal core and said surface element so that said core metal, said core material layer, and said surface element are integrated.

4. A manufacturing method for a steering wheel according to claim 2, wherein the step of forming a core material layer comprises injecting resin between said metal core and said surface element.

5. A manufacturing method for a steering wheel according to claim 3, wherein the step of forming a core material layer comprises injecting resin between said metal core and said surface element.
